(19) United States
(12) Patent Application Publication
(10) Pub. No.: US 2016/0278338 A1
(43) Pub. Date: Sep. 29, 2016

(54) AUTOMATIC TOILET FOR PET

(71) Applicant: Jiangsu Zhongheng Pet Articles Joint-Stock Co., Ltd., Jiangsu (CN)

(72) Inventor: Qiu Bin, Jiangsu (CN)

(73) Assignee: Jiangsu Zhongheng Pet Articles Joint-Stock Co., Ltd., Jiangsu (CN)

(21) Appl. No.: 15/082,568

(22) Filed: Mar. 28, 2016

(30) Foreign Application Priority Data
Mar. 27, 2015 (CN) 201510141250.1

(51) Int. Cl. A01K 1/01

(52) U.S. Cl. CPC A01K 1/0117

(57) ABSTRACT

An automatic toilet for pets includes a pet urinal pad supplying portion, a pet toilet working portion and a pet urinal pad recycling portion, wherein the pet urinal pad supplying portion includes a rectangular urinal pad case, a rolling shaft for transmitting urinal pads, two friction rollers and a one-way gear. Z-shaped folding urinal pads are stored in the urinal pad case, and the rolling shaft is driven by a gear motor to provide transmission power for moving the urinal pads. The urinal pad is clamped by the friction rollers, and the one-way gear prevents the cut-off urinal pad from retracting inward. The pet urinal pad recycling portion includes a housing, a recycling motor and a recycling roller for rolling the used pet urinal pad and collecting in the housing.

### CROSS-REFERENCE TO RELATED APPLICATIONS

This Application claims the priority of Chinese Patent Application No. 201510141250.1, filed on Mar. 27, 2015, the disclosure of which is incorporated by reference in its entirety.

### TECHNICAL FIELD

The present invention relates to an automatic pet toilet, which belongs to the technical field of pet toilets.

### BACKGROUND ART

Due to continuous improvement in living standards of people, as well as the gradually improved requirements of spiritual life, more and more people are fond of raising pets. Although pets are cute, a pet dog may void excrement and urine everywhere in the house, which can directly affect the indoor sanitation, especially when the pet owner goes out. In this way, the owner feels very troublesome.

Chinese inventive patent application publication number CN 101785435A discloses a toilet for automatically cleaning feces of a pet dog. The device stores urinal pads in a form of a roller. The roller has a large volume, and its volume becomes larger after rolling the urinal pads, resulting in an extremely large volume of the whole machine. This is inconvenient to place and transport, and a smaller number of urinal pads are stored. At the same time, the urinal pads are not supplied smoothly. It is difficult to supply the urinal pads when there are many urinal pads on the roller, thereby resulting in easy clamping/jamming. In addition, “the toilet for automatically cleaning feces of the pet dog” outputs the used urinal pads from the right side each time to lie flat on the ground, so the sanitary condition is poor and pungent smell can develop indoors to affect people's living conditions.

### SUMMARY OF THE INVENTION

A technical problem to be solved by the present invention relates to the fact that existing automatic toilets for pets store urinal pads in a form of a roller, wherein the roller has a large volume that will become larger after rolling the urinal pads, resulting in an extremely large volume for the whole machine. This is inconvenient to place and transport, and only a smaller number of urinal pads can be stored. Meanwhile, the urinal pads are not supplied smoothly, and it is difficult to supply the urinal pad when there are many urinal pads on the roller, thereby prone to clamping/jamming. In addition, the toilet outputs the used urinal pads from the right side each time to lie flat on the ground. As a result, the sanitary condition is poor and peculiar smell is developed indoors to affect people's living conditions.

An embodiment of the present invention adopts a technical solution as follows:

An automatic toilet for pets includes a pet urinal pad supplying portion 100, a pet toilet working portion 200, and a pet urinal pad recycling portion 300, wherein the pet urinal pad supplying portion 100 comprises a rectangular urinal pad case, a rolling shaft for transmitting the urinal pads, two friction rollers 1 at the outlet, and a one-way gear 2. Z-shaped folding (i.e., Z-fold) urinal pads 21 are stored in the urinal pad case and the rolling shaft is driven by a gear motor to provide transmission power for moving the urinal pads. The urinal pad is clamped by the friction rollers 1, and the one-way gear 2 prevents the cut-off urinal pad from retracting inward. The pet toilet working portion 200 is provided with a support plate 19 for pet stay, and the urinal pad provided by the pet urinal pad supplying portion 100 is placed on the support plate 19. A cut-off device bracket 17 is arranged on a base 16 and is provided with a covering material 7. A V-belt pulley 8 is connected with a cam 12 via a driving belt. The cam 12 is connected with a cutter 14, and the cutter 14 is provided with a spring. When the cam 12 rotates an angle, the cutter 14 starts down to cut off a composite feces bag. When the cam 12 rotates another angle, the cutter 14 gets back into the original shape via the spring. The belt of a programmable motor 18 is connected with a conveying roller 15, and a spring compression roller 13 in a concave shape is connected with the conveying roller 15. The spring compression roller 13 is provided with the spring to automatically adjust the degree of compression and tightness according to the size of feces of the pet. The support plate 19 is connected with the base 16 and is covered with a layer of urine pad. A computer control box 11 is a process center for controlling the motions of the whole machine by computer programming. An infrared probe 5 is arranged in the center position of the left side of a protective cover 4. The pet urinal pad recycling portion 300 includes a housing, a recycling motor and a recycling roller for rolling and collecting the used pet urinal pad in the housing.

In a further embodiment, the rectangular urinal pad case is provided with a lid 20, and the lid 20 is provided with a bar-type hole for extending out (passing) the urinal pad 12.

In a further embodiment, the rolling shaft of the pet urinal pad supplying portion synchronously works with the conveying roller 15 of the pet toilet working portion to provide the transmission power for the urine pad.

The present invention has one or more of the following beneficial effects.

1) the pet urinal pad supplying portion has a small volume, is convenient to place and transport, and can store a number of urinal pads;

2) the urinal pad is supplied smoothly, without clamping stagnation;

3) the friction rollers and the one-way gear effectively prevent the cut-off urinal ad from retracting inward; and

4) the pet urinal pad recycling portion recycles the used urinal pads to improve sanitary conditions, thereby avoiding the peculiar smell and improving the life quality indoors.

### BRIEF DESCRIPTION OF THE DRAWINGS

FIG. 1 shows an outside structural illustration of a pet urinal pad supplying portion in accordance with one embodiment of the invention.

FIG. 2 shows a detailed structural illustration of the pet urinal pad supplying portion in accordance with one embodiment of the invention.

FIG. 3 shows a schematic structural diagram of a pet toilet working portion in accordance with one embodiment of the invention.

FIG. 4 is a schematic structural drawing of the pet urinal pad recycling portion in accordance with one embodiment of the invention

FIG. 5 is a whole schematic structural diagram of a automatic toilet for pets according to one embodiment of the invention.

In the Figs., 1 refers to friction rollers, 2 refers to a one-way gear, 4 refers to a protective cover, 5 refers to an infrared probe, 6 refers to a sensor, 7 refers to a covering material, 8 refers to a V-belt pulley, 9 refers to a driving belt, 10 refers to a V-belt, 11 refers to a computer control box, 12 refers to a cam, 13 refers to a spring, 14 refers to a cutter, 15 refers to a conveying roller, 16 refers to a base, 17 refers to a cut-off device bracket, 18 refers to a programmable motor, 19 refers to a support plate, 20 refers to a lid, 21 refers to a Z-shaped folding urine pad, 100 refers to a pet urinal pad supplying portion, 200 refers to a pet toilet working portion, and 300 refers to a pet urinal pad recycling portion.

### DETAILED DESCRIPTION

The present invention will be further descried hereinafter with references to the drawings and exemplary embodiments.

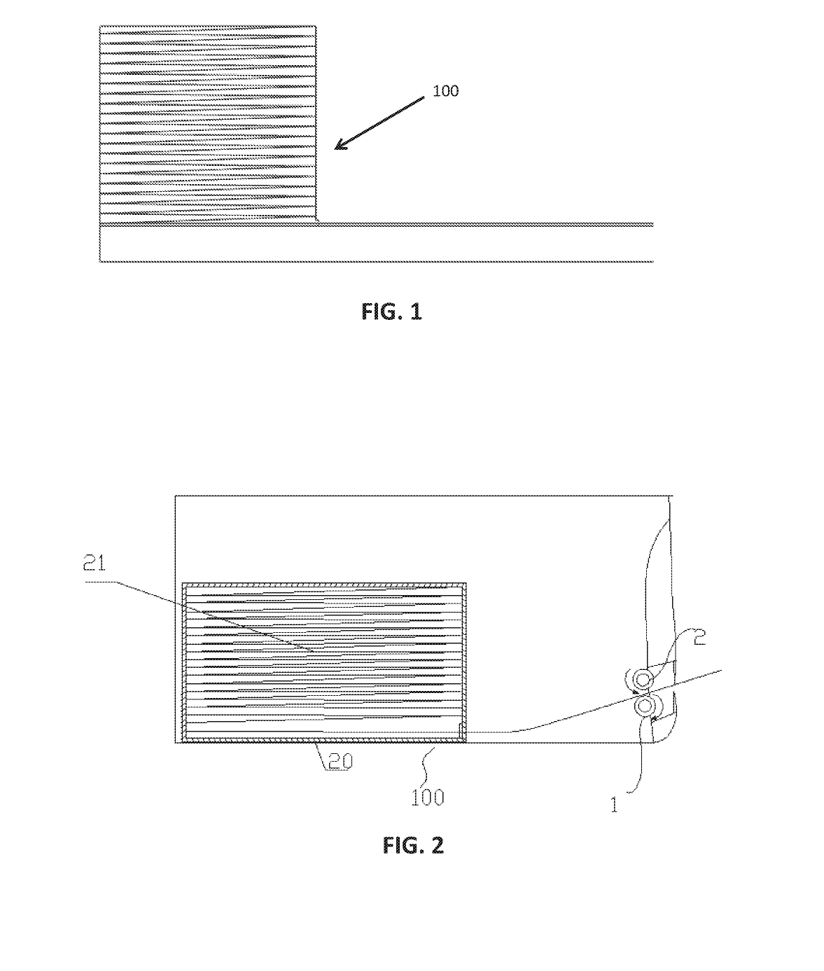

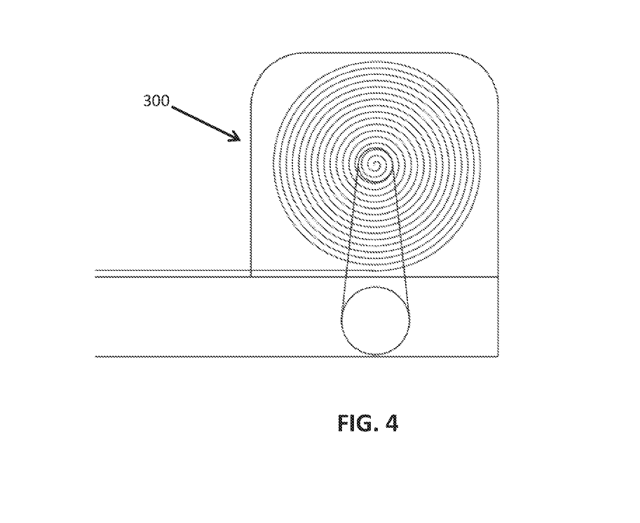

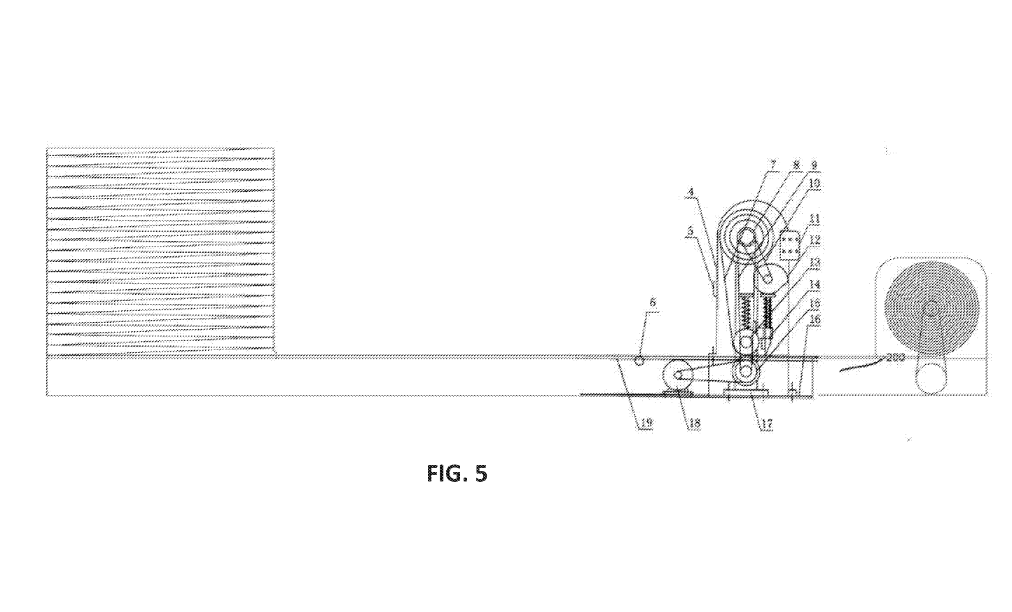

Referring to FIG. 1 to FIG. 4, an automatic toilet for pets includes a pet urinal pad supplying portion 100, a pet toilet working portion 200, and a pet urinal pad recycling portion 300. The pet urinal pad supplying portion 100 includes a rectangular urinal pad case, a rolling shaft for transmitting urinal pads, two friction rollers 1 at the outlet, and a one-way gear 2 (FIG. 2). Z-shaped folding (Z-fold) urinal pads 21 are stored in the urinal pad case. The rolling shaft is driven by a gear motor to provide transmission power for moving the urinal pads. The urinal pad is damped (held) by the friction rollers 1, and the one-way gear 2 prevents the cut-off urinal pad from retracting inward (FIG. 2).

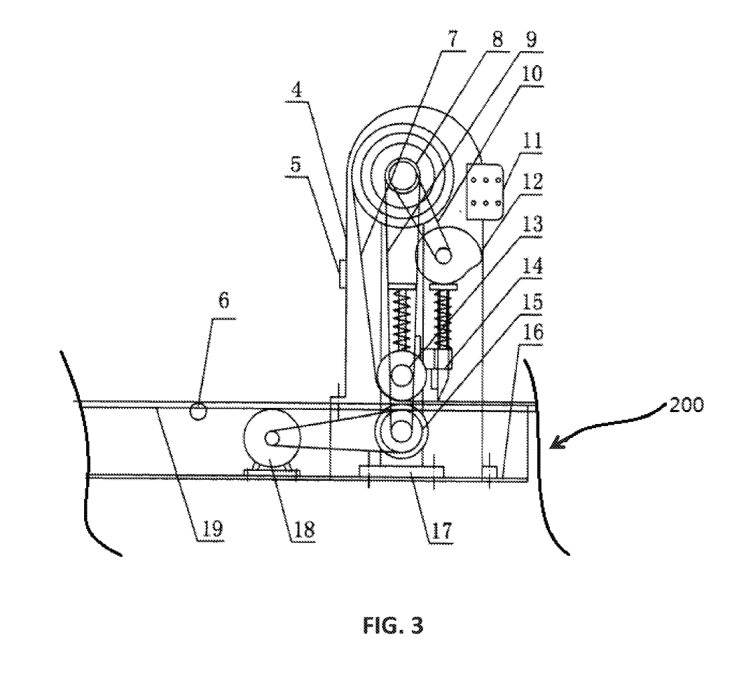

Referring to FIG. 3, the pet toilet working portion 200 is provided with a support plate 19 where a pet can stay. The urinal pad provided by the pet urinal pad supplying portion 100 is placed on the support plate 19, and a cut-off device bracket 17 is arranged on a base 16 and is provided with a covering material 7. A V-belt pulley 8 is connected with a cam 12 via a driving belt. The cam 12 is connected with a cutter 14. The cutter 14 is provided with a spring. When the cam 12 rotates an angle, the cutter 14 starts down to cut off a pet urinal or composite feces bag. When the cam 12 rotates another angle, the cutter 14 gets back into the original shape via the spring. The belt of a programmable motor 18 is connected with a conveying roller 15. A spring compression roller 13 in a concave shape is connected with the conveying roller 15 and is provided with a spring to automatically adjust the degree of compression and tightness according to the size of feces of the pet. The support plate 19 is connected with the base 16 and is covered with a layer of urine pad. A computer control box 11 is a process center for controlling the motions of the whole machine by computer programming. An infrared probe 5 is arranged in the center position of the left side of a protective cover 4. The pet urinal pad recycling portion 300 includes a housing, a recycling motor and a recycling roller for rolling the used pet urinal pad and collecting in the housing.

Referring to FIG. 2, the rectangular urinal pad case is provided with a lid 20, and the lid 20 is provided with a bar-shaped hole (slot) for extending out (passing) the urinal pad 12.

Referring to FIG. 3, the rolling shaft of the pet urinal pad supplying portion synchronously works with the conveying roller 15 of the pet toilet working portion to provide the transmission power for the urine pad.

The pet urinal pad supplying portion of the automatic toilet for pets has a small volume, is convenient to place and transport, and can store a number of urinal pads. The urinal pad is supplied smoothly, without clamping stagnation. The friction rollers and the one-way gear effectively prevent the cut-off urinal pad from retracting inward. The pet urinal pad recycling portion recycles the used urinal pads to improve sanitary conditions, thereby avoiding the peculiar smell and improving the life quality.

While embodiments of the invention have been illustrated with a limited number of examples, one skilled in the art would appreciate that modifications and variations are possible without departing from the scope of the invention. Accordingly, the scope of protection should be determined by the attached claims.

What is claimed is:

1. An automatic toilet for pets, comprising:
a pet urinal pad supplying portion (100), a pet toilet wt g portion (200) and a pet urinal pad recycling portion (300),
wherein the pet urinal pad supplying portion (100) comprises a rectangular urinal pad case, a rolling shaft for transporting urinal pads, two friction rollers (1) at an outlet, and a one-way gear (2);
wherein Z-shaped folding urinal pads (21) are stored in the urinal pad case, wherein the rolling shaft is driven by a gear motor to provide transmission power for moving the urinal pads; wherein the urinal pad is clamped by the friction rollers (1), and wherein the one-way gear (2) prevents the cut-off urinal pad from retracting inward;
wherein the pet toilet working portion (200) is provided with a support plate (19), the urinal pad provided by the pet urinal pad supplying portion (100) is placed on the support plate (19), a cut-off device bracket (17) is arranged on a base (16) and is provided with a covering material (7), a V-belt pulley (8) is connected with a cam (12) via a driving belt, the cam (12) is connected with a cutter (14), the cutter (14) is provided with a spring; when the cam (12) rotates an angle, the cutter (14) starts down to cut off a composite feces bag; when the cam (12) rotates another angle, the cutter (14) gets back into original shape via the spring; the belt of a programmable motor (18) is connected with a conveying roller (15), a spring compression roller (13) in a concave shape is connected with the conveying roller (15) and is provided with the spring to automatically adjust the degree of compression and tightness according to the size of feces of the pet, the support plate (19) is connected with the base (16) and is covered with a layer of urine pad, a computer control box (11) is a procedure center of controlling the motion of the whole machine by computer programming; and an infrared probe (5) is arranged in the center position of the left side of a protective cover (4); and
wherein the pet urinal pad recycling portion (300) comprises a housing, a recycling motor and a recycling roller for rolling the used pet urinal pad and collecting in the housing.

2. The automatic toilet for pets according to claim 1, wherein the rectangular urinal pad case is provided with a lid (20), and the lid (20) is provided with a bar-type hole for extending out the urinal pad (12).

3. The automatic toilet for pets according to claim 1, wherein the rolling shaft of the pet urinal pad supplying portion synchronously works with the conveying roller (15) of the pet toilet working portion to provide the transmission power for the urine pad.
